(19) United States
(12) Patent Application Publication
(10) Pub. No.: US 2018/0357572 A1
(43) Pub. Date: Dec. 13, 2018

(54) Contiguous Event Seating Across Temporal Ticketing Intervals

(71) Applicant: Amazon Technologies, Inc., Seattle, WA (US)

(72) Inventors: Kias Hafiz, Shoreline, WA (US); Xuan Li, Bellevue, WA (US); Steve L. Huynh, Seattle, WA (US); Patrick R. Schultz, Sammamish, WA (US)

(21) Appl. No.: 15/621,820

(22) Filed: Jun. 13, 2017

(51) Int. Cl. G06Q 10/02

(52) U.S. Cl. CPC G06Q 10/02; G06F 17/30

(57) ABSTRACT

A ticketing system allows a group of people to purchase individual tickets for an event and sit together even though the tickets are purchased separately. The ticketing system is able to encumber a block of seats and provide a block identifier that allows subsequent purchasers to purchase seats within the block of seats if they provide the block identifier. The block of seats is encumbered for an encumbrance duration, which may be established, or updated, based upon the popularity, or changing popularity, of the event.

### BACKGROUND

When offering tickets to an event, a ticketing system will typically make the selected seats temporarily unavailable to other purchases while the transaction is completed. If the transaction is not completed within a predefined amount of time, the transaction is cancelled and the selected seats are made available to any purchaser. Where a group of people desired to attend an event and be seated together, one person must select and purchase the seats and can then be reimbursed by other members of the group for individual tickets already purchased.

However, complications arise where the size of the group changes subsequent to the ticket purchase. For example, some members of the group who initially indicated a desire to attend the event may later decide they are unable to attend. This can present problems where a group ticket purchaser desires to be reimbursed from other event attendees. Furthermore, additional people may desire to attend the event with the members of the group, but with the tickets already purchased, the additional people are left to purchase tickets for themselves, usually in a different area of the venue.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a block diagram illustrating an example of a ticketing system providing for contiguous seating.

FIG. 2 is a flow diagram of an example process for contiguous seating with temporally spaced ticketing transactions.

FIG. 3 is a flow diagram of an example process for seat encumbrancing.

FIG. 4 is a flow diagram of an example process for establishing and offering one or more seats within a block of seats using a block identifier.

FIG. 5 is a flow diagram of an example process for dynamically activating and determining seat encumbrancing.

FIG. 6 is a flow diagram of an example process for dynamically determining a block of seats and optimizing seat selection within the block of seats.

FIG. 7 is a block diagram of an example ticketing system.

While implementations are described herein by way of example, those skilled in the art will recognize that the implementations are not limited to the examples or drawings described. It should be understood that the drawings and detailed description thereto are not intended to limit implementations to the particular form disclosed but, on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to.

### DETAILED DESCRIPTION

Embodiments of the present disclosure are directed to, among other things, methods and systems for contiguous event seating across temporal ticketing intervals. Groups of people often desire to attend an event and wish to seat together to commonly enjoy the event. Rather than elect a single person to purchase all the tickets for the group, the systems and methods described herein allow a group of friends to individually purchase their tickets to an event while allowing them to sit together, even if the tickets are purchased at different times, or even on different days.

This is possible through a ticketing system that provides the option for a first purchaser of one or more tickets to reserve additional seats within the vicinity of the purchased seats for interested friends. The interested friends can be given a link to purchase seats to the event adjacent to the purchased seats. In some embodiments, a first purchaser can designate a number of seats to be reserved for potential friends to purchase. The system encumbers a block of seats and assigns an identifier to the block of seats. Subsequently, additional purchasers can purchase one or more seats within the block of seats. If all the seats within the block of seats are not purchased within a predetermined time period, the remaining seats within the block are released for purchase by other purchasers.

According to some embodiments a system is provided that includes one or more processors and one or more memories coupled to the one or more processors. The memory stores instructions that, when executed by the one or more processors, cause the one or more processors to receive an order for one or more tickets to an event. The tickets are associated with individual seats that authorize the purchaser to attend the event. The processors additionally receive a request to reserve additional seats to the event. In response, the processors determine the seats to encumber, which are selected to be adjacent to the seats for which tickets have been sold. The sold seats and the reserved additional seats for a block of seats. The seats in the block of seats are encumbered for a predetermined encumbrance period, which may be initially predetermined, such as for a day, a fraction of a day, or an integer multiple of a day. The processors determine an identifier for the block of seats. That is, a unique identifier of the block of seats allows a subsequent purchaser to purchase a ticket associated with one or more of the reserved seats. A second order is received, the second order can include the identifier. If there are unsold seats within the block of seats (i.e., seats that are not associated with a purchase of tickets) at the expiration of the encumbrance period, the unsold seats are released for sale to the general public.

In some cases, determining seats to encumber includes executing an algorithm, such as a seat optimizer algorithm, to reduce single seat availability. That is, the processors select seats to alleviate a single seat either at the end of a row, or in the middle of a row adjacent to sold seats.

The popularity of the event can be determined, such as by a velocity of ticket sales. In other words, if tickets to the event are selling quickly, this indicates that the event is very popular. In some cases, the encumbrance period is determined, at least in part, upon the popularity of the event. In these situations, the duration of the encumbrance period may be dynamically changed inversely proportionally to a change in the popularity of the event. That is, as the ticket sales velocity is relatively high, the encumbrance period may be quite low, such as a day or even a fraction of a day. Conversely, as the ticket sales velocity slow, the encumbrance period may be lengthened.

The identifier of the block of seats may be included in a uniform resource locator (“URL”) and provided to the first purchaser, who can then distribute the URL to friends and family to allow purchase of the reserved seats within the block of seats.

According to some embodiments, a method includes receiving a request for one or more purchased seats and one or more reserved seats at a venue hosting an event. A seat map for the event at the venue is determined. In some cases, the seat map may be made available, such as through a database of seat maps and may be based upon the venue and the event. The seat map may further indicate which seats are available for purchase or reservation. As used herein, when referring to purchasing seats at an event, it should be appreciated that in actuality, this terminology relates to purchasing a ticket associated with a particular seat that provides the purchaser the authorization to sit in the “purchase seat” during the event.

The method further includes determining an identification of the one or more purchased seats and the one or more reserved seats to form a block of adjacent seats. That is, the seats are identified, usually by section number, row number, and seat number, or some other cataloguing method for identifying individual seats at a venue. The block of adjacent seats may be encumbered for an encumbrance period. That is, the reserved seats are not available for sale to the general public during the encumbrance period.

A block identifier for the block of adjacent seats is determined, which may be a unique code, symbol, phrase, password, or the like that can be used to identify the block of reserved seats. Subsequently, a request to purchase a ticket associated with one or more of the block of adjacent seats is received. In many cases, the request includes the block identifier.

When a request to purchase a seat in the block of seats is received, a seat optimization algorithm is executed to identify seats that are adjacent to the purchased seats. This identification may be based upon at least a number of seats in the block of adjacent seats and the available seats within the block of adjacent seats. It may additionally be based upon the seat map and the layout of the seats in the venue. For example, the seat optimization algorithm may reduce the number of single unsold seats that are not immediately adjacent to other available seats. The method further includes sending, in response to the request to purchase a ticket, an offer to purchase a ticket associated with a seat that is adjacent to the purchased seats. In this way, a subsequent ticket purchaser who has the block identifier, can purchase seats that are adjacent to friends and family who have already purchased tickets.

In some cases, determining a block identifier includes generating a uniform resource locator that includes the block identifier. The URL may be used as a link to visit a web page where tickets are sold that correspond to reserved seats within the block of seats.

When subsequent tickets are sold, the subsequent purchaser may be given the option to extend the encumbrance period. Additionally, the subsequent purchaser may be given the option to add additional seats to the block of adjacent seats.

The popularity of the event may be determined based upon a sales velocity of tickets to the event. The popularity may increase or decrease over time. In some cases, encumbering the block of adjacent seats for an encumbrance period is based, at least in part, upon the popularity of the event. In other words, as popularity of the event decreases, the encumbrance period may increase. In some cases, there may be no initial opportunity to reserve and encumber seats; however, as the popularity of the event decreases, the option to reserve and encumber a block of seats may then be provided.

A ticketing method that allows for contiguous seating includes receiving a first request for a first number of seats to an event. Based upon the request, the method can determine a location of the first number of seats that are adjacent to one another to form a block of seats. That is, the method can determine which seats in the venue are available and designate a block of seats that meet the requested number of seats. The individual seats are identified, such as by section, row, and seat number. The seats within the block of seats can then be encumbered. The method can conduct a first transaction for a second number of seats within the block of seats, the second number of seats being less than the first number of seats. That is, while a number of seats may be reserved, the transaction includes purchasing less than the reserved number of seats. An identifier of the block of seats can be generated, which can subsequently be used to allow other purchasers to purchase the reserved seats within the block of seats.

A second request for a third number of seats is received, and where the second request includes the identifier, the second request may allow another user to purchase one or more of the reserved seats. A second transaction may be conducted for a third number of seats where the third number of seats are selected to be adjacent to the second number of seats. That is, within the encumbered block of seats, a second purchaser is provided seats that are adjacent to seats already purchased. This provides that there are no empty seats between the first purchaser and the second purchaser so that at the time of the event, the group of people purchasing the reserved seats will all be sitting together, with no empty seats, or strangers, seated amongst them.

The ticketing method includes determining an encumbrance period, which may be based, at least in part, upon determining the popularity of the event. In some instances, seats within the block of seats that have not sold at the expiration of the encumbrance period are released for sale to the general public. In some cases, additional seats can be added to the block of seats which results in those additional seats being encumbered for an encumbrance period.

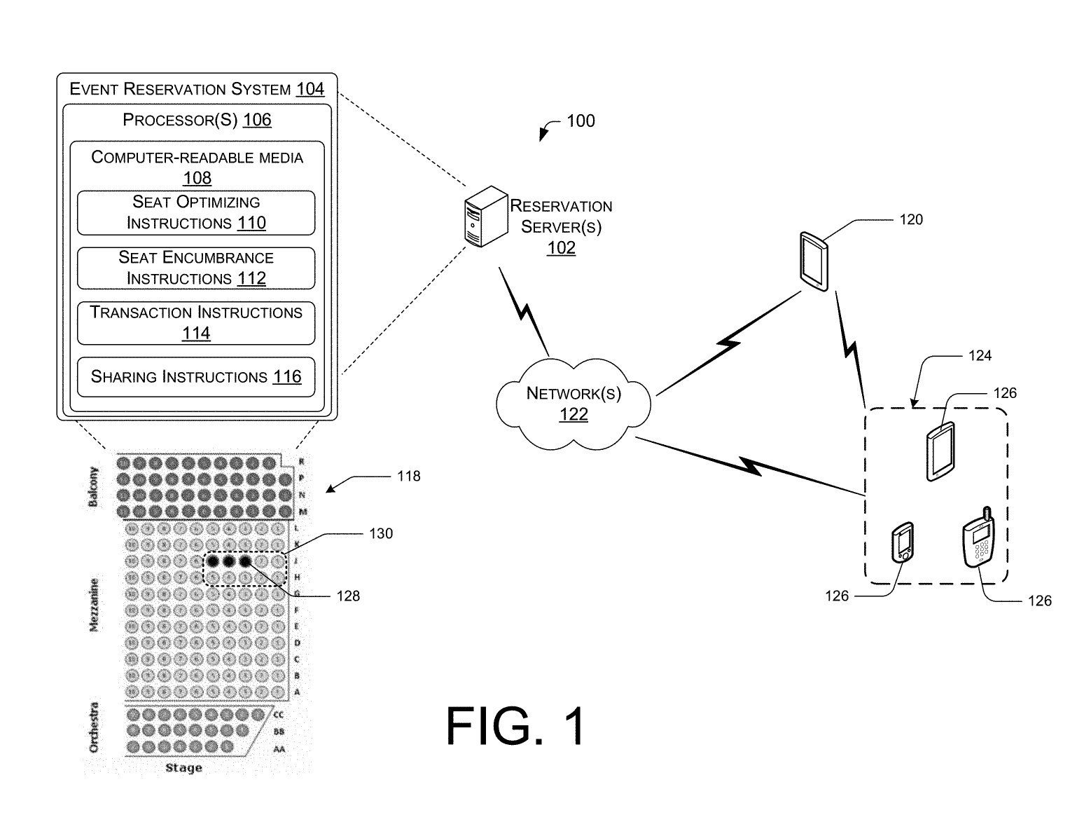

FIG. 1 is a block diagram illustrating an example of a ticketing system 100 that provides for contiguous seating across temporal ticketing intervals. In other words, contiguous seats can be purchased by a group of friends or family at separate times and by separate purchasers. One or more reservation servers 102 execute an event reservation system 104. The event reservation system 104 includes one or more processors 106. While the described system 100 may include different types and different numbers of processors 106, for efficiency, a single processor 106 will be referred to herein, but should not be construed as limiting. Furthermore, while the system 100 is described as incorporating one or more reservation servers 102, it should be appreciated that the system and its functionality can be offered as a cloud-based service where some, or all, of the described features can be shared between multiple computing devices spread across various locations. As such, reference to a reservation server 102 is intended to encompass and include a cloud-based service and associated hardware and software.

The processor 106 executes instructions stored on computer-readable storage media 108. The computer-readable storage media 108 is non-transitory and may store various instructions, routines, operations, and modules that, when executed, cause the processor 106 to perform various activities. In some implementations, the processor 102 may be a central processor unit (CPU), a graphics processing unit (GPU) or both CPU and GPU, or any other sort of processing unit. The non-transitory computer-readable storage media 108 may include volatile and nonvolatile, removable and non-removable tangible, physical media implemented in technology for storage of information, such as computer readable instructions, data structures, program modules, or other data. System memory, removable storage, and non-removable storage are all examples of non-transitory computer-readable media. Non-transitory computer-readable storage media may include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, physical medium which can be used to store the desired information.

The computer-readable storage media 108 stores sets of instructions including a seat optimizing algorithm 110, seat encumbrance instructions 112, transaction instructions 114, and sharing instructions 116.

The event reservation system 104 may store a seating map 118 of one or more venues (e.g., a stadium, a theatre, an auditorium, an arena, a music venue, etc.), such as in a database. The seating map 118 may be presented to a user device 120 by the reservation server 102 in response to a request for available seats to a scheduled event. The reservation server 102 may send and receive data over a network 122, which may be wired or wireless. The user device 120 may be associated with a user who has a group of friends 124 (or other individuals, such as co-workers, relatives, etc.) that also have other devices 126.

In use, user device 120 may send a request through network 122 to reservation server 102 inquiring about available seats to a scheduled event (e.g., a sports game, a play, a movie, a concert, etc.). The reservation server 102 may retrieve information from a database related to the event, such as the schedule for the event, the venue, the available seats, and the price for each seat or group of seats. The reservation server 102 may send data to the user device 120 that includes the seating map 118 and identifies the available seats, such as by color, shading, texture, or some other indication of the seats that are available. Alternatively, the request may indicate a number of desired seats and the reservation server 102 may select available seats and offer them to the user device 120.

The user associated with the user device 120 may select three seats for purchase (“purchased seats”) 128 and be provided with the option to select an additional number of seats for friends or family who may wish to join the user at the event. The user, through the user device 120, may indicate an additional number of seats to hold for potential friends or family.

The reservation server 102 may encumber an additional number of seats adjacent to the purchased seats 128 and reserve these seats as a block of seats 130. The reservation server 102 may assign a block identifier to the block of seats 130 that can be used to purchase additional seats with the block of seats 130.

A notification can be sent to the group of friends 124 by the reservation server 102, or by the user associated with the user device 120 that includes a block identifier, or a link to purchase seats, wherein the link includes the block identifier. The link may be a uniform resource locator (“URL”) that includes the internet address and the block identifier to allow another user to purchase encumbered seats within the block. In this way, the group of friends 124 are able to purchase one or more seats within the block of seats 130 before they are made available to the general public. The encumbrance of the block of seats 130 may be timebound, which may be based upon the popularity of the event.

The seat optimizing instructions 110 may cause the event reservation system 104 to select the seats to include within the block of seats 130, and may additionally select the order of the seats that are sold to the group of friends 124. For example, where the block of seats 130 includes a block of ten seats as illustrated, and the first user purchased three seats, the seat optimizing instructions 110 may cause the system 104 to find a block of available seats that encompasses five seats on two adjacent rows, where the five seats are adjacent front and back to one another. That is, the block of ten seats is a contiguous array of two rows of five seats each.

The seat optimizing instructions 110 may further determine that the three initially purchased seats 128 should not be on the end of the row, but rather, should be toward the center of the section in which the seats are located. In some cases, the seats located at the end of a row adjacent an aisle are more sought after, and keeping the two end seats open may allow them to be sold in case the entire block of seats are not purchased by the group of friends 124. Moreover, the seat optimizing instructions 110 may determine that the three initially purchased seats 128 should be at one end or the other of the row of five seats. In this way, a single seat is not left available adjacent to the occupied seats. A single seat may be less desirable than a grouping of two or three adjacent seats, and the seat optimizing instructions 110 are able to make these determinations to provide the opportunity for the maximum number of ticket sales.

The seat encumbrance instructions 112 allow the reservation server 102 to encumber the seats within the block of seats 130 so that they are at least temporarily unavailable to other purchasers who do not have the block identifier. The encumbrancing of the seats within the block of seats 130 may be timebound, such as for twenty-four hours, forty-eight hours, a week, or some other interval of time. This provides other members within the group of friends 124 a sufficient amount of time to decide whether to attend the event and purchase tickets within the encumbered block of seats 130.

The transaction instructions 114 executed by the reservation servers 102 allow the user device 120 to complete a purchase for tickets associated with the selected seats 128. This may include instructions related to financial processing of credit or debit card payments, triggering the distribution of tickets whether physical or electronic, and permanently encumbering the purchased seats, among other things.

The sharing instructions 116 allow the reservation server 102 to provide a block identifier to the user device 120 or directly to the other user devices 126. The notification may be a link that embeds the block identifier, such that when one of the other user devices 126 follows the link, the available seats within the block of seats 130 are displayed and available for selection and purchase. The user device 120 may provide information that identifies the group of friends 124, which may include a mobile telephone number, an email address, a social media identity, or some other form of identification that allows the reservation server 102 to send a notification directly to the group of friends 124.

In some embodiments, a link that includes the block identifier is provided to the user, who is then free to distribute that link to whomever she chooses. In some cases, the user may provide the link to a large group of people, such as by sharing the link on social media with information related to the event, and the tickets associated with the block of seats 130 may be on a first-come-first-served basis to the group with which the link has been shared.

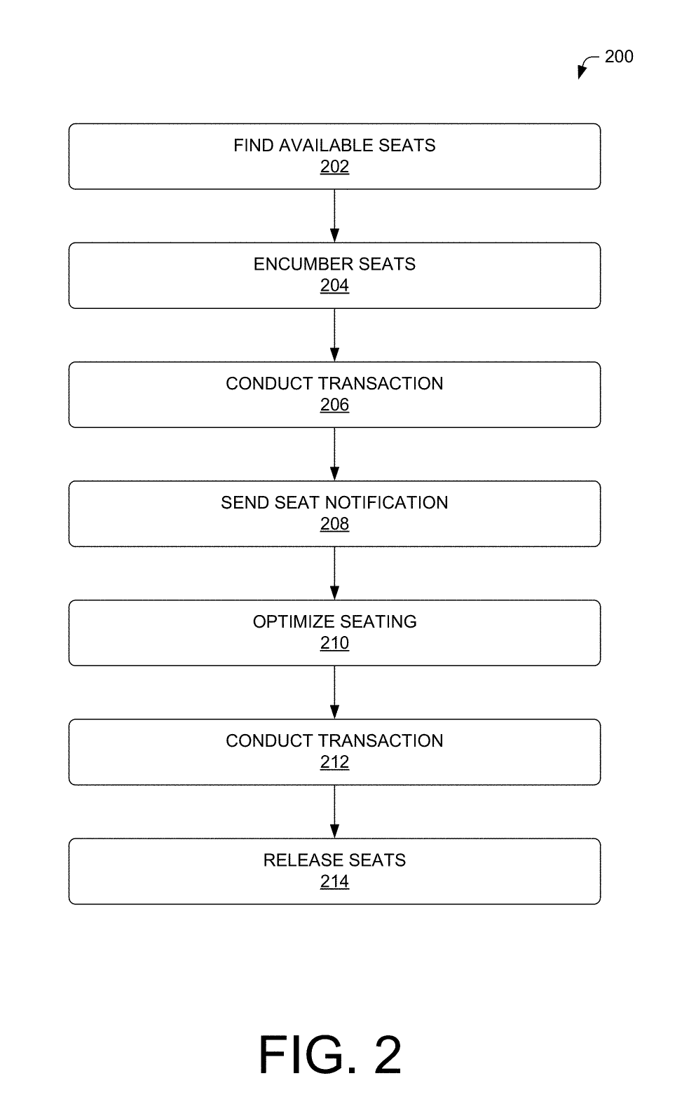

With reference to FIG. 2, an example process 200 for contiguous seating with temporally spaced ticketing transactions is provided. At block 202, the system searches for available seats. This process may receive as an input, a desired section, a desired price or price range, a desired number of tickets, and a show date and show time. The system may find one or more alternative seat locations that meet the requested criteria and provide these locations to a user.

At block 204, one or more seats are encumbered. This may be performed, for example, when a user selects one or more seats for purchase. The seat encumbrance based upon seat selection may be limited in time, such as for ten minutes, or twenty minutes, or some other time interval to provide the user with ample time to complete the transaction for the selected seats.

At block 206, the transaction for the purchase of the selected seats in completed. At this point, the selected seats may be permanently encumbered so that they are not offered for sale to another purchaser. The transaction may additional include the option for the user to select additional seats to be offered to friends or family members. Of course, the option for the user to select additional seats may be performed prior to conducting the transaction, and may be one of the inputs used when initially searching for available seats that meet the requested criteria. For example, the user may indicate a desire to search for a block of twelve seats and then complete a transaction to purchase four of the seats, and offer the remaining eight seats in the block to friends and family members. If this option is selected, then at block 208, a notification can be sent to the friends or family members.

When a user selects additional seats for friends or family, the system may select the additional seats, assign a block identifier associated with the additional seats, and temporarily encumber the additional seats. The block identifier may be provided to the user, who is free to distribute the block identifier narrowly, such as to a targeted list of people with whom he wishes to attend the event, or may blast broadcast the link, such as through mass email, social media posts, or otherwise, and make the invite available to a larger number of people than there are seats in the block.

At block 210, the seats are optimized. In other words, as additional people use the block identifier and desire to purchase seats within the block, the seats are optimized to retain the future value of potentially unsold seats. For example, where a block of seats includes five seats in a row, and a purchaser desires to purchase four of the seats, the purchased seats will preferably be at one end of the block of six seats, so that single seats are not left unoccupied. This is because a single seat is less desirable than two adjacent seats. Likewise, continuing with the example, the four purchased seats will be contiguous within the block of six seats so that there are no empty seats in between the purchased seats.

In some instances, where a user uses the link and enters a desired number of tickets, the system will automatically select the seats within the block for the user, as determined by the seat optimizer 110.

At block 212, the user completes a transaction to purchase one or more of the seats in the block of seats. The user may be provided an option to add additional seats to the block of seats, if available. The user may enter a desired number of additional seats, and the system can determine if contiguous seats are available and add them to the block of encumbered seats, thereby encumbering additional seats for future purchase.

At block 214, the encumbered seats are released. In some instances, the seats within the block of seats will not be purchased within a predetermined time period for encumbrancing. In this case, the unpurchased seats may return to the general pool of available seats for purchase by another customer.

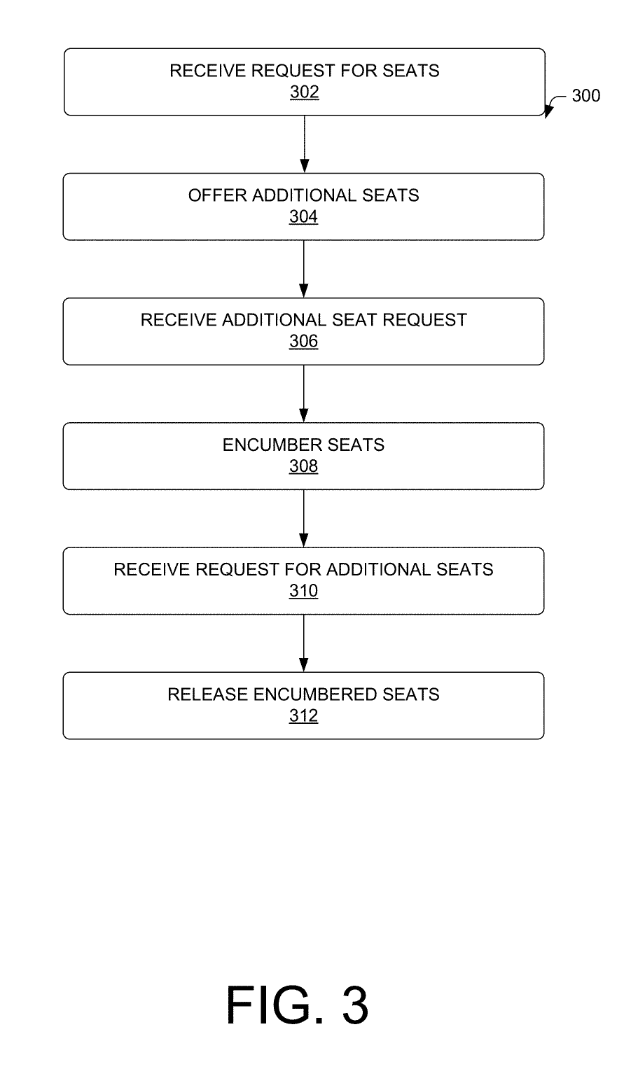

With reference to FIG. 3, an example process for seat encumbrancing 300 is illustrated. At block 302, the system receives a request for a specified number of seats. During the ordering process, during the checkout process, or after the checkout process, a user may be given the option to request additional seats that are adjacent to the purchased seats.

For example, at block 304, additional seats may be offered to the user who initially requested the seats. That is, the system may notify the user that there are available seats adjacent to the requested seats and provide the user with an opportunity to reserve one or more of the adjacent seats for later purchase by friends or family members. This offer for additional seats may be optional. Alternatively, it may provide as an option to be included with the seat request, such as by allowing a purchaser to initially specify a number of seats to purchase and a number of seats to reserve. It may also be provided during the checkout process, or after the checkout process has been completed.

At block 306, a request for additional seats is received, which as described, may be during ordering or after ordering. In any event, the additional seats are seats that a user is not purchasing, but rather, wants to make available for family and friends to purchase so that the group of people can sit by each other and enjoy the event together.

At block 308, the additional seats are encumbered, even though they have not yet been purchased. As described, the additional seats within the block may be selected to preserve the value of unsold seats. For example, where a row of seats includes ten seats and the request is to encumber nine seats, rather than encumber all nine seats in the same row and leave a single seat available for another purchase, the nine seats may be selected to occupy two rows adjacent to one another. This prevents a row from having a single seat available to other purchasers, but rather, leaves a grouping of four seats in one row, and a grouping of five seats in another row that are available to another consumer for purchase.

At block 310, the system receives a request for additional seats within the block of encumbered seats. If the request is for less than the remaining amount of available seats in the block, the system may decide which seats will be provided in response to the request. For example, continuing with the previous example in which each row of the venue includes ten seats and the initial encumbrance is for nine seats, where a request for additional seats includes a request for four seats, those four seats may be provided by offering two seats on each of two rows. This has the effect of not only keeping the group of friends in the closest proximity to one another, but also may prevent leaving a single seat available at the end of a row. Furthermore, the additional seats may be selected such that they are contiguous with the seats that have already been purchased, rather than leaving available seats within the block of seats in between the purchased seats within the block of seats.

In some cases, the system may identify which friends have purchased specific seats. In this way, subsequent purchasers may be able to decide the specific seats they wish to purchase within the block of seats so they can be assured of sitting next to a particular person.

At block 312, after a predetermined time period, the available seats that were previously encumbered within the block of seats that have not been purchased are released for general sale to the public. This may be based upon a predetermine amount of time, such as one day, two days, and so forth. In other cases, the encumbrance time may depend upon the popularity of an event. For example, the popularity of an event may be known before tickets become available, and a relatively short encumbrance time may be preselected. In other cases, the popularity of the event may be determined based upon the rate at which the seats are being sold and encumbered. In this case, the encumbrance time may be adjusted based upon the increasing, or decreasing, popularity of the event. In some cases, the velocity of ticket sales may exceed a threshold velocity, which may trigger an adjustment of the encumbrance time. Additionally, where the ticket sales velocity crosses a threshold (which may by an increase above a threshold or a decrease below a threshold), the ability to encumber additional seats may be activated or deactivated. For example, where the ticket sale velocity is above a threshold, such as for example where tickets are selling at a velocity of greater than 100 tickets per minute, the purchasers may not be given an option to reserve additional seats. However, where the ticket sales velocity falls below a threshold (e.g., 10 tickets per minute), the option to reserve additional seats may be activated and the encumbrance time may be based, at least in part, on the ticket sales velocity.

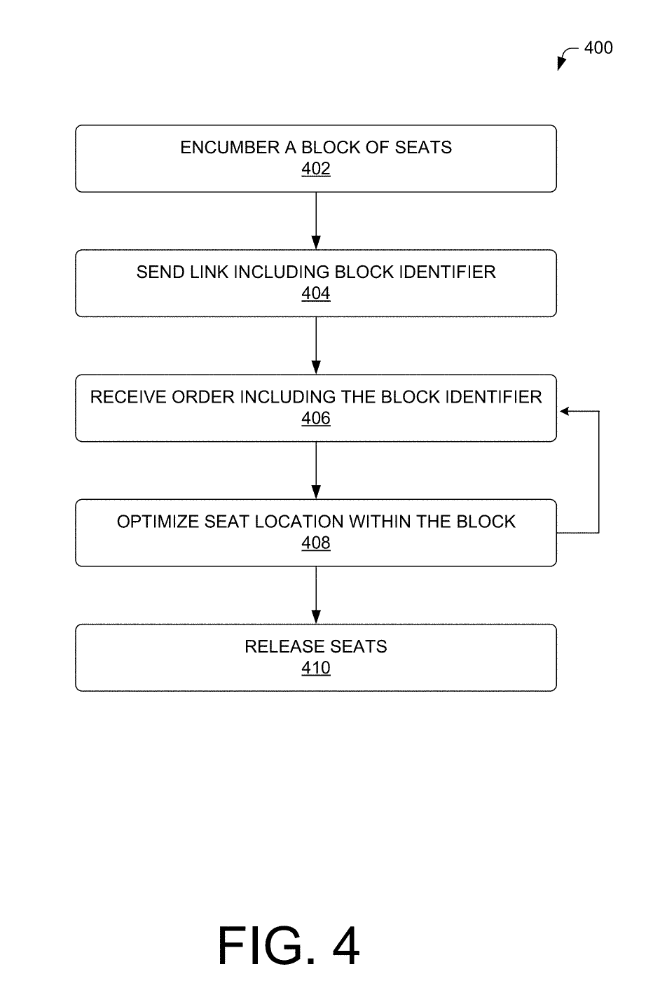

With reference to FIG. 4, an example process for establishing and offering one or more seats within a block of seats using a block identifier 400 is illustrated.

At block 402, a block of seats is encumbered. This may be performed at a time when a user requests a number of seats, which may be a number greater than the number of seats the user desires to purchase. The encumbrance may also happen in response to a user requesting a desired number of seats which may be during the period of time in which the user is searching for available seats, or may happen during the checkout procedure, or may happen following a successful transaction in which the user purchases one or more tickets associated with the selected seats.

At block 404, a link that includes the block identifier is sent. The system preferably creates a block identifier that identifies the block of seats that are encumbered as a result of the user requesting additional seats that the user does not pay for. The link including the block identifier may be provided directly to the user, who is then free to share it with whomever she wishes. Alternatively, or in addition, the link may be sent directly to other friends that the user identifies. In some embodiments, the link is posted to a social media site where connected friends of the user are able to use the link to purchase one or more of the encumbered seats within the block of seats.

At block 406, an order for one or more of the encumbered seats within the block of seats is received. In some cases, an order is received when another user follows the link that includes the block identifier and is provided with an option to purchase one or more of the remaining available seats within the block of seats associated with the block identifier. The other user may purchase one or more of the available seats within the block, and may optionally be provided the option to encumber additional seats that are contiguous with the block of seats, which may be based upon availability and popularity of the event. In some cases, when another user purchases one or more of the encumbered seats within the block of seats, the time period for encumbering the seats may be extended. Optionally, the other user may be provided a link to the block of seats, have the option to post the link to a social media site, or be provided a new link that includes a new block identifier in those cases in which the block of encumbered seats is expanded from the initial encumbrance. In some instances, the block identifier remains the same, but the number of encumbered seats within the block may be expanded.

At block 408, the seat locations are optimized within the block of seats. That is, when another user desires to purchase one or more seats within the encumbered block of seats, the system may determine which seats the other user is able to purchase. This may be based, at least in part, upon the layout of the block of seats and the number of seats the other user desires to purchase. For example, where the block of seats includes two available seats adjacent an aisle of the venue, and the other user desires to purchase a single seat, the system may offer the other user a seat other than a seat adjacent to the aisle as that location would result in a single empty seat adjacent the aisle. In some cases, the system may identify the purchaser or previously purchased seats so that the other user can select her seat based upon the location of the previously purchased seats.

The process may return to block 406 with subsequent orders for seats within the block of seats. As described, the block of encumbered seats may be expanded to include additional seats beyond the initially encumbered block of seats.

At block 410, the available seats within the block of seats are released for sale to the general public. This may be based upon a time period from the initial encumbrance of the seats, based upon the most recent purchase of seats within the block of seats, upon the popularity of the event, or on some other metric.

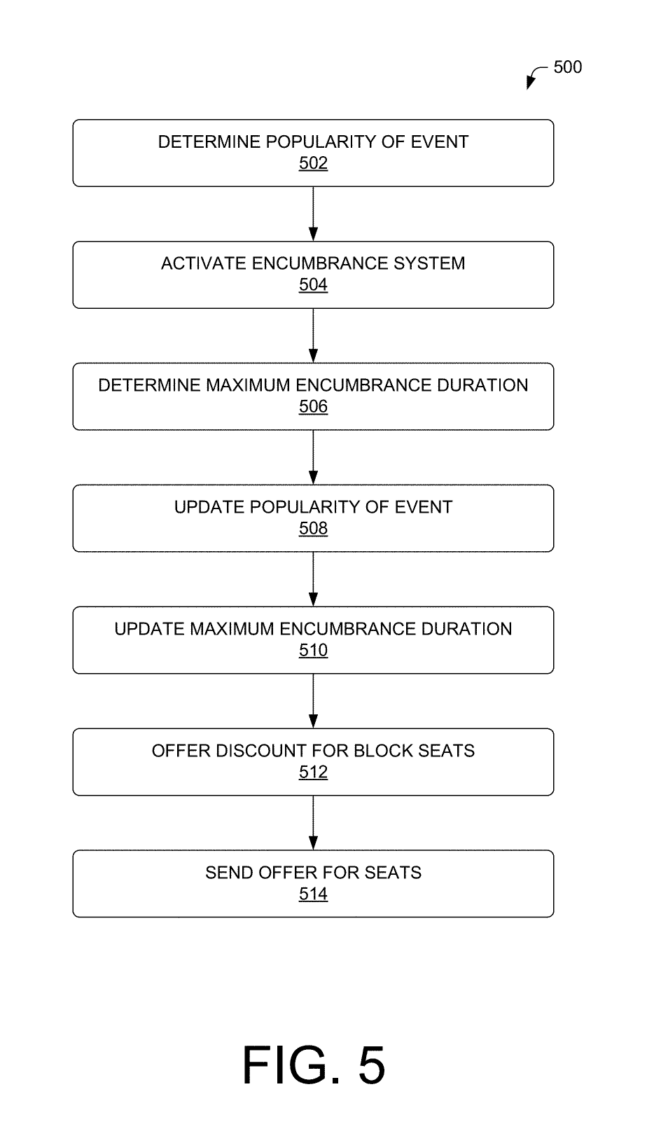

With reference to FIG. 5, a process for dynamically activating and determining seat encumbrancing 500 is illustrated. At block 502, the popularity of the event is determined. An event's popularity may be based, for example, upon prior sales of the event at the same or a different venue, or prior sales of a similar or related event at the same or a different venue. As an example, a singer may have previous performances sold out in a matter of days, which may indicate a high popularity. Where an event is expected to have a high popularity, the encumbrance system may not even be used and the tickets may all be sold on a first-come-first-served basis. In other cases, the encumbrance duration may be set to a very low duration.

At block 504, the encumbrance system is activated, which may be based upon the popularity of an event. For example, for a highly popular event, the encumbrance system may not be employed while for an event having a low or medium expected popularity, the encumbrancing system may be activated immediately upon the on-sale date for tickets to the event.

At block 506, the maximum encumbrance duration is determined. This may be determined based upon the popularity of the event, the time until the event is schedule to take place, the number of available tickets, and other factors that influence the demand for the tickets.

At block 508, the popularity of the event is updated. This may be based upon the ticket sale rate, which can be used to gauge the popularity of an event. The popularity may also decrease as initial ticket sales may be sold at a very high cadence, but as the demand from the early ticket purchasers is met, the ticket sales cadence may slow dramatically, thus indicating a decreasing popularity.

At block 510, the maximum encumbrance duration is updated. In some cases, the maximum encumbrance duration is inversely proportional to the popularity of the event. That is, where the popularity of an event decreases over time, the maximum encumbrance duration may be increased. The converse is also true in that where the popularity of an event increases, the maximum encumbrance duration may be decreased.

At block 512, a discounted offer for encumbered seats within a block of seats may be provided. For example, where a first user indicates a desire to encumber ten seats that are made available to friends for subsequent purchase, the system may determine that if all ten seats within the block of seats are sold, the purchasers may be refunded a percentage of the purchase price. This may provide additional incentives for the first user and the friends of the first user to promote the event to even more friends which can result in increased ticket sales for the venue.

At block 514, an offer for seats may be sent. For example, for available seats within a block of seats, the system may send an offer to purchasers of seats within the block to purchase additional seats within the block at a discounted price. This may result in additional ticket sales, especially as the event draws nearer and the venue still have many available seats for purchase. The encumbered seats within a block may be more attractive to friends of the previous purchasers of seats within the block, and offering a discount for seats may drive additional ticket sales, especially when the potential purchasers can be assured of sitting near their friends.

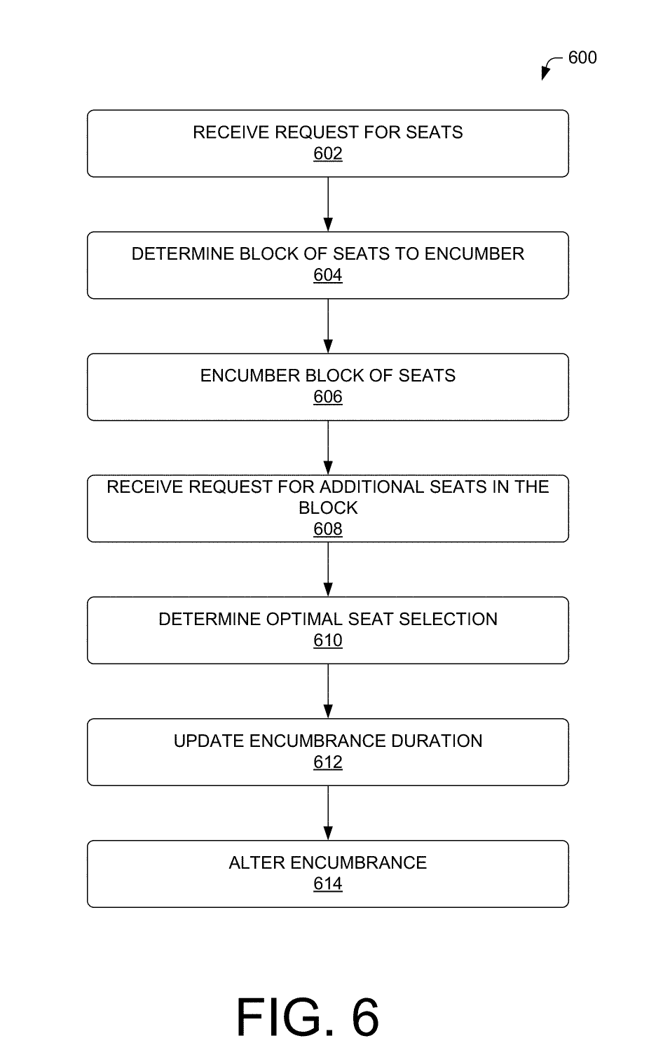

FIG. 6 illustrates an example process for dynamically determining a block of seats and optimizing seat selection within the block of seats. At block 602, a request for seats is received. Accompanying the request for seats may be a request to reserve additional seats, thus forming a block of seats. The system may encumber the seats to provide an opportunity for friends of the initial purchaser to have the first option at purchasing seats adjacent to their friend. The system may determine a block of adjacent seats to encumber based upon several factors, including the number of seats desired, the number of seats initially purchased, the popularity of the venue, the price for a ticket to each seat, the layout of the seats in the venue, among other things. For example, where a first user indicates a desire to encumber ten seats and the venue offers rows containing ten seats in each row, the system may determine to provide an array of seats comprising five seats in two adjacent rows rather than providing all ten seats in a single row. This allows the group of friends to be closer in proximity to one another and enjoy the event together.

At block 606, the desired number of seats is encumbered. As described, this may be done at the time the user requests the additional seats, during or after the checkout process in which the first user purchases one or more seats, or at some other time during the seat selection/purchase process. In some cases, this is done during the time that the first user is viewing available seats before purchase because the first user may base his seat purchase on the availability of adjacent seats. The maximum number of seats to encumber may be specified by the venue, the promoter, or may be determined by the system such as based upon the popularity of the event or the total number of available seats to the event.

At block 608, a second request for additional seats in the block is received. As described, a block identifier, which may be included in a link sent to other potential purchasers, can be used to allow subsequent purchasers to acquire the encumbered seats. In some cases, the block identifier may be a password or phrase selected by the first purchaser and provided to his friends. As the friends browse available seats, they may have the option to enter the password or phrase to have access to purchase one or more of the encumbered seats within the block.

At block 610, the system determines the optimal seat selection. The system may ascertain which seats in the block are available, and in combination with the number of requested seats, can determine which seats in the block provide for the optimal seat selection. As an example, the system may determine to select seats that are contiguous with seats already purchased rather than leaving empty seats between purchased seats within a block. Additionally, the system may determine to select seats within the block so that there is not a single seat left at the aisle, or a single seat left in the middle of a row of seats.

At block 612, the encumbrance duration may be updated. In some instances, the encumbrance duration is determined based upon the popularity of the event. In some cases, the encumbrance duration may be extended by one or more purchasers of the encumbered seats in the block.

At block 614, the encumbrance of the block of seats may be altered. For example, where a user desires to purchase one or more seats within the encumbered block of seats, the user may have the option to add additional seats to the block of seats such as to accommodate additional friends that may desire to attend the event. Similarly, where a purchaser knows that one or more friends who had planned on purchasing tickets to the event are unable to attend, one or more of the encumbered seats may be removed from the block of seats, thereby making those seats available to the general public.

According to some embodiments, additional items may be offered to ticket purchasers and in some cases, the additional items may relate to the event. For example, where the event is a music concert, clothing associated with the performer, such as a tee-shirt or hat may be offered to the ticket purchasers. The additional items may be offered at a promotional discount if purchased with the tickets to the event.

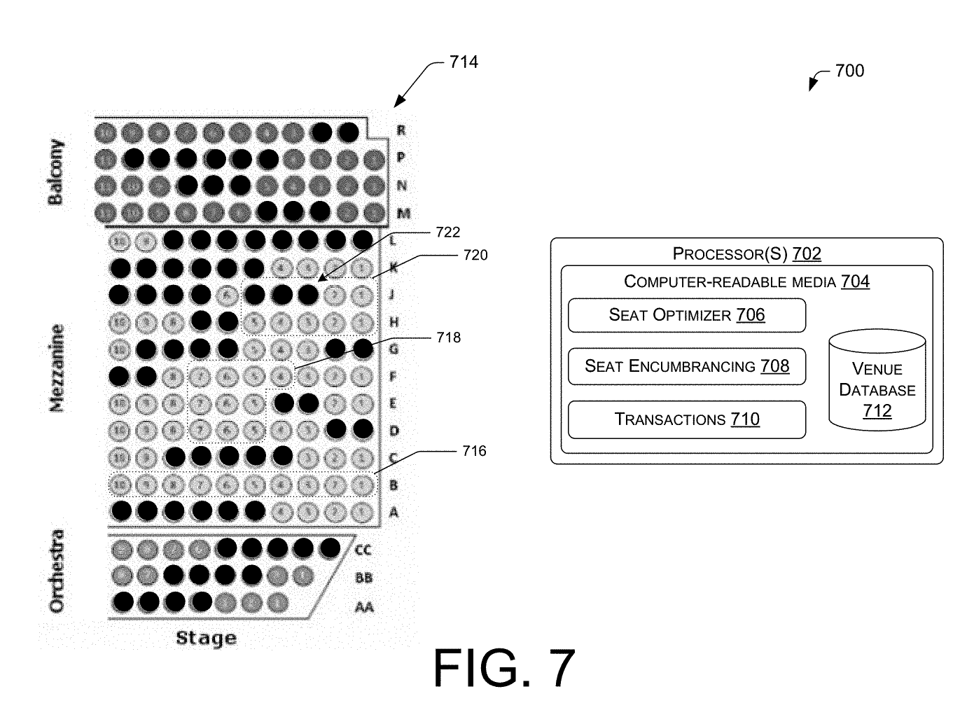

With reference to FIG. 7, a ticketing system 700 is shown as a block diagram. According to some embodiments, the ticketing system 700 includes one or more processors 702 in communication with computer-readable media 704. Of course, as described above, it should be apparent that the system and methods described herein could be performed as a cloud-based solution, and so the functions of a single processor and media may be implemented as a series of shared computing resources spread across a large geographic area.

The computer-readable media 704 stores instructions that result in a seat optimizer 706, seat encumbrancing 710, and transactions 712. The computer-readable media 704 may store a venue database 712 which may include inventory data associated with encumbered and available seats to an event. Of course, the processors 702 may gain access to a venue database 712 stored remotely from the computer-readable media 702.

In use, the seat optimizer 706 assists a purchaser with finding available seats at a venue for a specific event. As an example, where a first purchaser indicates a desire to reserve ten seats at an event in the mezzanine section, the seat optimizer 706 may retrieve a seating chart 714 from the venue database 712 that is specific to the venue and to the event. The seat optimizer 706 may further determine which seats are already encumbered (shown as filled in circles) and thus unable for reservation by the purchaser. The seat optimizer 706 may identify three locations within the venue that have available seats that meet the seating criteria requested by the purchaser.

The first block of seats 716 may be presented to the purchaser with the option of reserving the entire row of ten seats. Upon recommending the block of seats to the purchaser, the instructions for seat encumbrancing 708 may temporarily encumber all the seats in the block of seats until the purchaser has sufficient time to either complete the transaction of the seats, or indicate a desire to search for alternate seats. The purchaser may indicate that he does not want all ten seats to be on the same row, and the first block of seats 716 may be immediately unencumbered, thereby making them available for another purchaser.

The seat optimizer 706 may next recommend a second block of seats 718 containing four seats in a single row, and two rows of three seats each. The second block of seats 718 may be temporarily encumbered until the purchaser indicates a desire to search for additional seats, at which point, the encumbrance may be released and the seats are returned to the pool of available seats.

The seat optimizer may next recommend a third block of seats 720 containing two rows of five seats each. The third block of seats 720 may be temporarily encumbered and the purchaser may indicate a desire to reserve the third block of seats 720 and may immediately purchase three of the seats 722. The transactions instructions 710 allow the purchaser to proceed with a purchase of tickets associated with the selected seats. This may require specialized data processing capabilities, brokering connections, concurrency controls, atomicity controls, and security, among other specialized features.

The specialized data processing capabilities may allow numerous transactions to occur simultaneously. For example, brokering connections may allow the workload of processing transactions to be distributed among multiple computing resources over a network. The concurrency controls provide that two purchasers will not be able to access and change the same data at the same time. This may be handled by the encumbrance capabilities of the system so that two purchasers will not be able to purchase tickets associated with the same seat, even if those two transactions are occurring at the same time. Atomicity controls ensure that the steps in the transaction are all completed as a group. Conversely, the atomicity controls provide that if a part of the transaction fails, then all steps in the transaction also fail.

The purchased seats 722 may be permanently encumbered, and the remaining seats in the third block of seats 720 may continue to be temporarily encumbered, but the encumbrance may be extended to allow one or more second purchasers to have time to acquire the reserved seats within the third block 720.

The combination of the seat optimizer 706, seat encumbrancing 708, and the transactions 710, among other things, results in a system that solves a unique dilemma with online ticketing. A specific-purpose system is created that can not only determine available seats, but can also determine available blocks of seats and encumber a block of seats even in the absence of an immediate ticket purchase associated with those seats. As described herein, a specific set of rules allows the seat optimizer to select seats that preserves the value of the non-selected seats. For example, when determining a block of seats, or providing seats within a block to a second or third purchaser, the system can provide seats that will tend to leave two or more available seats together, rather than leaving a single available seat in the midst of purchased seats, or at the end of a row. As an example, where a row of seats contains ten seats and a purchaser requests nine seats to be reserved, rather than select nine seats on a single row that results in a single available seat within that row, the system may select a row of five seats and an adjacent row of four seats, thereby leaving available five seats on one row and six seats on the adjacent row available for other purchasers. Of course, other constraints may be provided by the optimizer, many of which may be specified by the venue, the event coordinator, or others.

A system that is capable of reserving a block of seats provides increased efficiencies. For example, a second purchaser who has a block identifier that is generated in response to a first purchaser reserving a block of seats, need not conduct repeated searches for available seats trying to find seats that are in proximity to the first purchaser who has already purchased tickets for the event. The block identifier allows the second purchaser to immediately view available seats that are adjacent to other friends who have already purchased seats. This allows a group of friends (or family, coworkers, etc.) to find seats adjacent to one another even when the seats are purchased at different times. The result is fewer database queries, a reduced number of searches for available seats, less bandwidth, a more efficient process, and an improved functioning of the ticketing system.

From the foregoing, it will be appreciated that, although specific implementations have been described herein for purposes of illustration, various modifications may be made without deviating from the spirit and scope of the appended claims and the elements recited therein. In addition, while certain aspects are presented below in certain claim forms, the inventors contemplate the various aspects in any available claim form. For example, while only some aspects may currently be recited as being embodied in a particular configuration, other aspects may likewise be so embodied. Various modifications and changes may be made as would be obvious to a person skilled in the art having the benefit of this disclosure. It is intended to embrace all such modifications and changes and, accordingly, the above description is to be regarded in an illustrative rather than a restrictive sense.

What is claimed is:

1. A system comprising:
one or more processors; and
one or more memories coupled to the one or more processors, the one or more memories storing instructions that, when executed by the one or more processors, cause the one or more processors to:
receive, from a first device of a first purchaser, a first order for one or more first tickets to an event, the one or more first tickets associated with purchased seats that authorize the first purchaser to attend the event;
receive, from the first device, a request to reserve one or more additional seats to the event;
determine one or more seats, the one or more seats selected to be adjacent to the purchased seats;
associate an encumbrance with the one or more seats for a predetermined encumbrance period;
determine an identifier for the one or more seats;
receive, from a second device of a second purchaser, a second order for one or more second tickets, the one or more second tickets associated with at least a portion of the one or more seats, the second order including the identifier; and
release, at an expiration of the encumbrance period, the encumbrance on the one or more seats that are not associated with a purchase of tickets.

2. The system as in claim 1, wherein determining the one or more seats to encumber includes executing a seat optimization algorithm that identifies one or more available seats that are adjacent to the one or more seats to encumber and selecting the one or more seats to encumber such that there are two or more available seats adjacent to the seats to encumber.

3. The system as in claim 1, wherein the one or more processors determine a popularity of the event based at least in part upon a velocity of ticket sales being above a threshold.

4. The system as in claim 3, the instructions causing the one or more processors to determine the encumbrance period based at least in part upon the popularity of the event.

5. The system as in claim 3, the instructions causing the one or more processors to determine a change to the encumbrance period based upon an inverse relationship with a change in the popularity of the event.

6. The system as in claim 1, the instructions causing the one or more processors to provide, through an interface on the second device, an option to extend the encumbrance period of the one or more seats.

7. The system as in claim 1, the instruction causing the processors to generate a uniform resource locator that includes the identifier and provide the uniform resource locator to the first device of the first purchaser.

8. A method comprising:
receiving a request for one or more purchased seats and one or more reserved seats at a venue hosting an event, the reserved seats being adjacent to the purchased seats;
determining a seat map for the event at the venue;
determining an identification of the one or more purchased seats and the one or more reserved seats to form a block of adjacent seats;
encumbering the block of adjacent seats for an encumbrance period;
determining a block identifier for the block of adjacent seats;
receiving a request to purchase a ticket associated with a seat of the block of adjacent seats;
executing a seat optimization algorithm that, based upon at least a number of seats in the block of adjacent seats and available seats within the block of adjacent seats, identifies seats that are adjacent to the purchased seats;
sending, in response to the request, an offer to purchase a ticket associated with the seat that is adjacent to the purchased seats.

9. The method as in claim 8, further comprising generating a uniform resource locator that includes the block identifier.

10. The method as in claim 8, wherein executing the seat optimization algorithm further includes identifying seats to reduce the number of single available seats that are contiguous to purchased seats.

11. The method as in claim 8, further comprising providing, in response to receiving the request, an option to extend the encumbrance period.

12. The method as in claim 8, further comprising:
providing, in response to receiving the request, an option to add additional seats to the block of adjacent seats; and
encumbering the additional seats for the encumbrance period.

13. The method as in claim 8, further comprising determining, based upon a sales velocity of tickets to the event, a popularity of the event.

14. The method as in claim 13, wherein encumbering the block of adjacent seats for an encumbrance period is based, at least in part, upon the popularity of the event.

15. The method as in claim 13, wherein encumbering the block of adjacent seats for an encumbrance period is based upon a declining popularity of the event.

16. A method comprising:
receiving a first request for a first number of seats to an event;
determining a location of the first number of seats to form a block of seats;
identifying first seats that correspond to the location of the first number of seats;
encumbering the first seats within the block of seats;
conducting a first transaction for one or more second seats within the block of seats, the one or more second seats being a portion of the first seats;
generating an identifier for the block of seats;
receiving a second request for a third number of seats, the second request including the identifier;
selecting, based on the second request, one or more third seats within the block of seats, the one or more third seats adjacent to the one or more second seats; and
conducting, based at least in part upon the second request, a second transaction for the one or more third seats within the block of seats.

17. The method of claim 16, further comprising determining an encumbrance period for the first seats and encumbering the first seats for the encumbrance period.

18. The method of claim 17, further comprising determining a popularity of the event and wherein the encumbrance period is based, at least in part, upon the popularity of the event.

19. The method of claim 17, further comprising unencumbering seats within the block of seats not associated with a transaction at the expiration of the encumbrance period.

20. The method of claim 16, further comprising adding additional seats to the block of seats and encumbering the additional seats for an encumbrance period.
